(19) United States
(12) Patent Application Publication
(10) Pub. No.: US 2008/0071806 A1
(43) Pub. Date: Mar. 20, 2008

(54) DIFFERENCE ANALYSIS FOR ELECTRONIC DATA INTERCHANGE (EDI) DATA DICTIONARY

(75) Inventors: Suraj Gaurav, Issaquah, WA (US); Surendra Machiraju, Issaquah, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/533,601

(22) Filed: Sep. 20, 2006

(51) Int. Cl. G06F 7/00

(52) U.S. Cl. 707/100

(57) ABSTRACT

A tree based EDI data dictionary difference analysis tool is provided that performs an analysis of tree structures of EDI building blocks that compose EDI schema to determine and display change histories for particular versions, or EDI building blocks, or the differences between EDI building blocks of two versions of an EDI schema. To intuitively represent changes made between two EDI schema, the differences are displayed as changes related to the EDI building blocks themselves, without interference from additional abstractions beyond the EDI building blocks, by a tool that utilizes the tree-based difference analysis. The tool also allows users to create new schema versions by editing existing schema objects, extending the change history for those edited schema objects.

### TECHNICAL FIELD

The subject disclosure relates to analyzing and displaying differences, such as version changes, among electronic data interchange (EDI) schema in a data store.

### BACKGROUND

Traditionally, with EDI, organizations have been empowered to send virtually limitless kinds of structured messages to one another to facilitate the communication of any kind of business data from one organization to another in automated ways. In this regard, once setup properly, EDI messages can be used to automate a variety of communications to and from partners, business sub-units, buyers, etc., thereby substantially reducing the overhead associated with filling out paper forms, storing volumes of papers, etc. With EDI, for instance, an organization merely fills out an electronic form in a manner conforming to a pre-defined schema, and then the messaging, storage/record keeping and validation of the message(s) associated with the electronic form occurs automatically.

EDI messages thus have an associated EDI schema that instructs an EDI system how to interpret a given EDI message instance, i.e., how to validate an EDI message has been structured correctly and with appropriate information. In this regard, there are thousands of EDI message types, also called transaction set definitions (TSDs). For instance, when an EDI message of a particular type, e.g., a purchase order, is created by an EDI system, the EDI message is created in a way that conforms to the purchase order schema. Today, XML Schema Definitions (XSDs), external data representations (XDRs) and document type definitions (DTDs) are typically used to represent schemas for EDI messages. In this regard, XSDs, XDRs and DTDs are schema files that can be created to describe the schema for a particular kind of EDI message. Today, these XSD, XDR and DTD files are stored as individual files that are used in connection with the validation and generation of EDI messages in an EDI system.

When an organization is maximizing the value of EDI messaging, however, the organization might be storing numerous schemas on behalf of the EDI system, and even numerous versions of the same schema. Once the number of schemas starts to exceed a few dozen, for instance, the storage requirements and version management of those schemas can become non-trivial. This is for a number of reasons. Trying to understand the differences among hundreds, or thousands, of EDI schema, and differences among the same versions, is difficult and complex, to say the least.

For instance, since many schemas evolve over time according to different versions, it would be desirable to be able to analyze those versions in order to quickly and efficiently determine what the differences are between the two versions, e.g., to select the correct version for a given set of circumstances. Today, the only way to compare two versions of the same EDI schema is to display the two separate schema files side by side so that a user can perform a line by line comparison of the differences while viewing the schema files in their native format (typically XML).

For instance, two different versions 1800a and 1800b of the same XML representation of a transaction set definition (TSD) are shown side by side in FIG. 18. The difference between the two versions is illustrated as change C1 of the maxLength value from ‘5’ to ‘2’ from version 1800a to 1800b. Similarly, in two differing versions 1810a and 1810b, an EDI TSD element name, as represented in XML, has undergone change C2 from 1810a to 1810b, changing the name from “RFFField1” to “ReferenceField1”. Observing these differences according to a line by line differencing analysis, however, is challenging due to the complexity of the schema representations. This requires users to be very familiar with XSDs, which is too challenging. There should be an easier way.

First, analyzing difference this way is difficult because it requires a thorough ability to read and understand XML and XSDs in order for the user to distill the XML formatting information from the EDI schema elements. This is error prone, i.e., a user can never be sure all changes have been observed from a manual review. In addition, if the changes from version to version become numerous or involve complex structural changes, any line by line comparison technique is woefully inadequate.

Additionally, EDI schemas are composed of many EDI elements, which can be customized according to different business needs. Accordingly, it would be desirable to have an EDI system that analyzes the differences between EDI schemas in terms of those EDI elements, as opposed to lines of an XML file, so that an intuitive understanding of the differences between schemas can be presented to the user in terms of the EDI elements that matter.

Accordingly, in consideration of the lack of sophistication of the current state of the art of version management of EDI schemas in an EDI communications system, it would be desirable to provide improved tools and storage management systems for improved understanding of the differences between EDI schemas in a data dictionary. These and other deficiencies in the state of the art of EDI messaging will become apparent upon description of the various exemplary non-limiting embodiments of the invention set forth in more detail below.

### SUMMARY

In consideration of the foregoing, tree based EDI data dictionary difference analysis tools are provided that perform an analysis of tree structures of EDI building blocks that compose EDI schema to determine and display change histories for particular versions, or EDI building blocks, or the differences between EDI building blocks of two versions of an EDI schema. To intuitively represent changes made between two EDI schemas, in various non-limiting embodiments, the differences are displayed as changes related to the EDI building blocks themselves, without interference from additional abstractions beyond the EDI building blocks, by a tool that utilizes the tree-based difference analysis. The tool also allows users to create new schema versions by editing existing schema objects, extending the change history for those edited schema objects, e.g., as stored in an EDI dictionary store.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The system and methods for analyzing differences of EDI schema in accordance with the present invention are further described with reference to the accompanying drawings in which:

FIG. 1 illustrates an exemplary tree-based representation of an EDI TSD in accordance with difference analysis techniques of the invention;

FIG. 2 is a block diagram illustrating a change from a first version of an EDI schema to a second version of the EDI schema that are tracked and displayed according to the various techniques of the invention;

FIG. 3 illustrates an aspect of reusable and versionable storage blocks in a relational database in accordance with various non-limiting embodiments of the invention;

FIG. 4 illustrates a storage representation for changes from version to version to minimize redundancy of storing many versions;

FIG. 5 illustrates an exemplary Data Type table for a dictionary for EDI schema data represented in relational format in accordance with a non-limiting embodiment of the invention;

FIG. 6 illustrates an exemplary Object Reference table for a dictionary for EDI schema data represented in relational format in accordance with a non-limiting embodiment of the invention;

FIG. 7 illustrates an exemplary Change Log Journal table for a dictionary for EDI schema data represented in relational format in accordance with a non-limiting embodiment of the invention;

FIG. 8 is a block diagram showing a representative example of a structural change to a tree-based representation in accordance with the change analysis techniques of the invention;

FIG. 9 is an exemplary table view of the way changes to EDI schema objects can be represented in a relational data store in accordance with the invention;

FIG. 10 is an exemplary system diagram illustrating the interaction of the change analysis component and corresponding user interface provided in accordance with the invention;

FIGS. 11, 12, 13 are flow diagrams illustrating exemplary non-limiting processes for using the difference analysis capabilities of the invention;

FIGS. 14A, 14B, 14C, 14D, 14E, 14F, 14G, 14H and 14I show an exemplary sequence of non-limiting UI screenshots from selection of a version of an EDI schema to editing of the EDI objects of the EDI schema, through to showing the differences between the new version and the second version in accordance with the tree-based difference analysis techniques of the invention;

FIG. 15 is an exemplary block diagram of a representative EDI communications system between a home organization having a server and the trading partners of the home organization;

FIG. 16 is an exemplary block diagram of a representative EDI system including a hub and spoke architecture;

FIG. 17 is an exemplary block diagram representative of an interchange data structure including a plurality of EDI transactions;

FIG. 18 is a block diagram representing problems with line based difference analysis;

FIG. 19 is a block diagram representing an exemplary non-limiting networked environment in which the present invention may be implemented; and

FIG. 20 is a block diagram representing an exemplary non-limiting computing system or operating environment in which the present invention may be implemented.

### DETAILED DESCRIPTION

### Overview

In consideration of the lack of adequate tools for analyzing and representing changes to EDI schema in today's EDI communications systems, in various non-limiting embodiments, the invention provides a tree based EDI data dictionary difference analysis tool that performs an analysis of tree structures of EDI building blocks that compose EDI schema to determine the differences between the EDI building blocks. The difference analysis tools can be used to determine the differences between two versions of the same EDI schema. To intuitively represent changes made between two EDI schemas, the differences can be displayed as changes to the EDI building blocks by a tool that utilizes the tree-based difference analysis, and allows users to edit the schema based on the EDI building blocks and thus create new versions as well.

By way of further background, each EDI message type has an associated TSD, which is composed of smaller building blocks like Loops, Segments, Composites, Simple Fields and Data Types. The TSDs undergo changes over time. In various non-limiting embodiments of the invention, a tool is provided that helps users to analyze these changes made over time and to version them. The tool intuitively represents changes between versions in terms of EDI data elements affected by the changes.

The tree based difference analysis tool thus eliminates shortcomings of existing line based systems that only perform line by line comparisons, offers an exact and precise rendition of changes in terms of EDI schema concepts independent of any additional type systems, such as XML, applied to represent the EDI schema, and eliminates guesswork with a simple user interface that automatically displays the changes between two schema in terms of the EDI building blocks that are affected. Differences are thus tracked in terms of higher level user constructs that makes review of the differences intuitive to the user.

In various non-limiting embodiments, move is treated as a first class command and not treated like cut and paste, which can be confusing to users. In other non-limiting embodiments, one master copy of data is maintained, and then utilizing the tree-based change analysis of the invention, all changes from the master are tracked as distinct operations to the EDI building blocks comprising the data. This leads to efficient storage and exact reconstruction of different versions of EDI schema quickly and efficiently.

### EDI Schema Elements as Tree Structures in Relational Store

In various non-limiting embodiments, the invention provides tools for versioning, editing and displaying EDI schemas. As mentioned, there are thousands of TSDs in an EDI system that represent EDI message types. With EDI, a TSD is identified by a DocType, which is a combination of namespace and root node name. More formally, this is described by the following relation:

DocType=TargetNamespace‘#’RootNodeName

X12 schemas are represented according to the following form: X12_{Version}_{TsId}. In this X12form, all schemas have a root node name that starts with ‘X12’. The ‘Version’ in turn represents the version of the document, which is a dynamic piece of information that is configuration or instance driven. Lastly, ‘TsId’ is the transaction identifier of the document being processed and is always read from the input instance.

Edifact schemas are represented according to the following form: Efact_{Version}_{Tsid} Thus, all Edifact schemas have a root node name that starts with ‘Efact’. ‘Version’ represents the version of the document, and ‘Version’ is a dynamic piece of information which is instance driven, i.e., configuration driven is not an option with Edifact schemas. ‘TsId’ again represents the transaction identifier of the document being processed and is always read from the input instance.

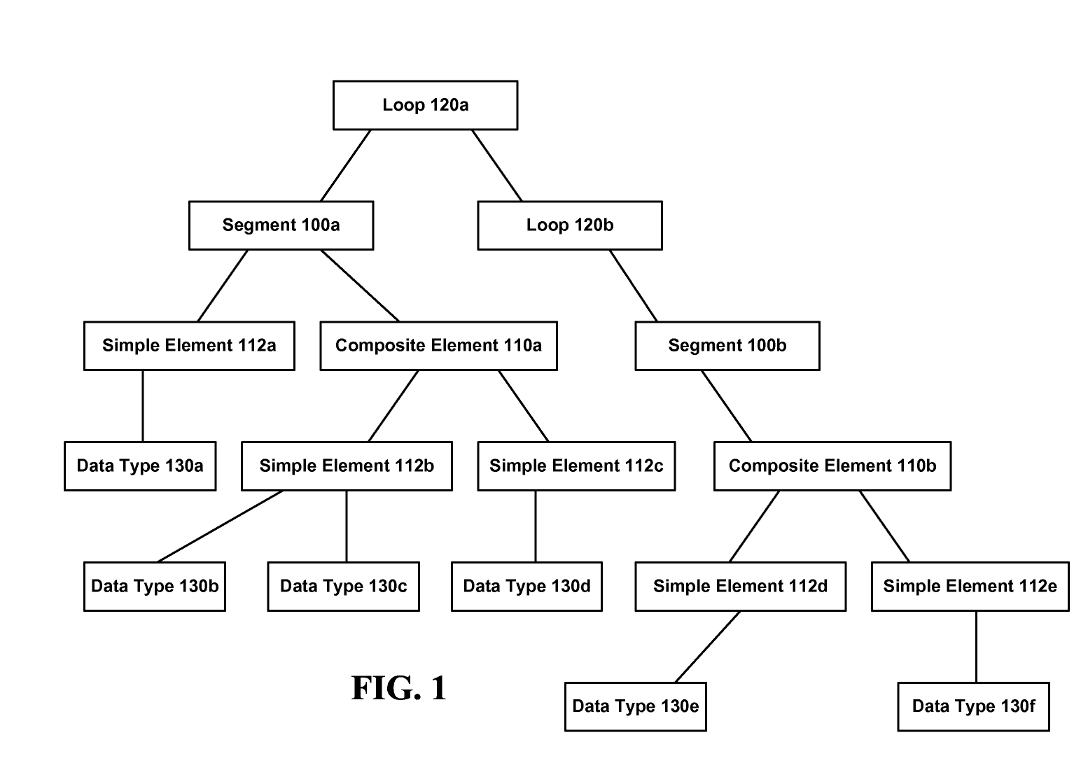

An EDI schema consists of a root node. Each root node can have a sequence of loops and segments as children. Loops can contain nested sub-loops or segments. The hierarchical tree structure of an exemplary TSD is illustrated in FIG. 1. At the lowest level of re-use in the presently described embodiment of the invention, data types 130a, 130b, 130c, 130d, 130e, 130f can be re-used across different schema TSDs. Then, at the next level are Simple Data Elements 112a, 112b, 112c, 112d, 112e, etc. that contain Data types. Composite Data Elements 110a and 110b contain other Simple Data Elements such as Simple Data Elements 112b and 112c and Simple Data Elements 112d and 112e, respectively. Segment 100a contains Simple Data Element 112a and Composite Data Element 110a. Segment 100b contains Composite Data Element 110b. Lastly, Loop 120a contains Loop 120b and Segment 100a, and Loop 120b further contains Segment 100b.

In more formal terms, an EDI document schema includes the following structure

Schema->RootNode

RootNode->(Block)+

Block->Segment|Loop

Loop->(Block)+

Segment->(DataElement)+, RuleSet

DataElement->SimpleField|CompositeField

SimpleField->name, dataTypeName

CompositeField->(SimpleField)+

In these more formal terms, segments 100a, 100b, etc. of the EDI schema of FIG. 1 thus include EDI Data Elements (“Data Elements”), including composite data elements that are collections of Data Elements. Data Elements include a name, and its minimum and maximum number of occurrences, and a Data Type, e.g., “AN” which means alphanumeric, or “N” which means numeric. Data Types for Data Elements can be defined to include a minimum length, a maximum length, a name (e.g., UOM—unit of measure), and values for the name (e.g., kg, ml, cc, lbs, etc.).

More specifically, X12 Data Types can be any of the following:

Nn—an integer type with an implied decimal point, specified by n>=0.

ID—an enumeration data type with optional length restrictions.

AN—an alphanumeric data type with length restrictions.

R—a real number.

Date—a date data type.

Time—a time data type

And Edifact data types can be defined to be any of the following:

A—an alphabetic data type with a length restriction.

N—a numeric data type with length restriction.

ID—an enumeration data type with optional length restrictions.

AN—an alphanumeric data type with length restrictions.

As mentioned in the background, in the past, these structures have been represented in XSDs, XDRs, DTDs, etc., i.e., as separate files. However, this does not leverage the powers that relational forms of storage have yielded for the storage of data. In this regard, in an exemplary, non-limiting aspect of the invention, EDI schema and the associated EDI Data Elements are stored as a relational schema, i.e., stored in a relational database as a relational file, e.g., Microsoft's Access files (MDB format), as described in more detail below. The tree structure of the EDI schema of FIG. 1 lends itself to efficient storage in a relational format, in that relational data structures are well suited to representing hierarchical tree data.

Thus, as discussed in the overview above, in one exemplary, non-limiting invention, the invention builds a data dictionary for EDI schema representing EDI Data in relational storage, such as the structured query language (SQL) format. As a result, EDI TSDs can be decomposed into smaller pieces which can be efficiently reused by other TSDs. Thus, in accordance with an exemplary embodiment of the invention, EDI building blocks that can be reused include Data types, Simple data elements containing DataTypes, Composite data elements that contain other Simple data elements, Segments that contain Simple and/or Composite elements and Loops that contain other Loops and/or Segments.

Any of Loops, Segments, Simple Data Elements, Composite Data Elements and/or Data Types can be re-used as EDI schema building blocks. In another exemplary, non-limiting aspect of the invention, each EDI building block is allowed to evolve over time and be modified, e.g., to reflect changing business needs. For instance, a business might move from America to Europe and have to switch a UOM (unit of measure) represented in an EDI schema from pounds to kilograms. In such a case, after such a change is made, today, there is no way to preserve the version information as the building blocks of the EDI schema change in a way that is meaningful to the data store representing the EDI schema.

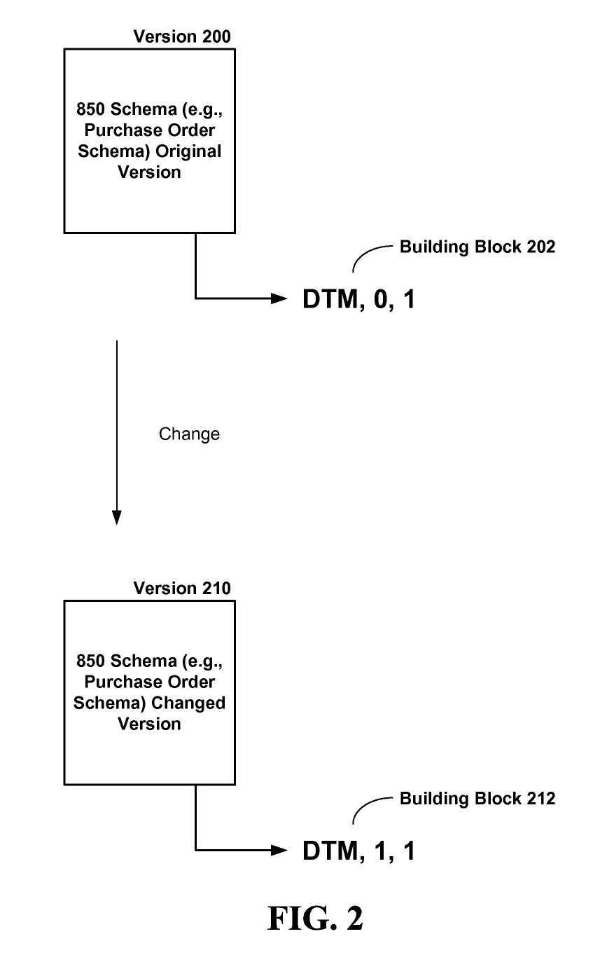

For another example, as shown in exemplary original version 200 of EDI 850 Schema (e.g., a Purchase Order Schema) in FIG. 2, the Schema includes a re-usable and versionable building block 202 that currently has no Date/Time Reference (DTM) requirement, as designated by the zero. However, if a customer then demands that the Purchase Order start using the DTM, the Schema must be changed resulting in Version 210 and Building Block 212. In accordance with the invention, building block 212 becomes a version of building block 202, editing the EDI building block 202 is performed in terms of the building block itself, and the changes from building block 202 to building block 212 can be quickly displayed using the difference analysis techniques of the invention.

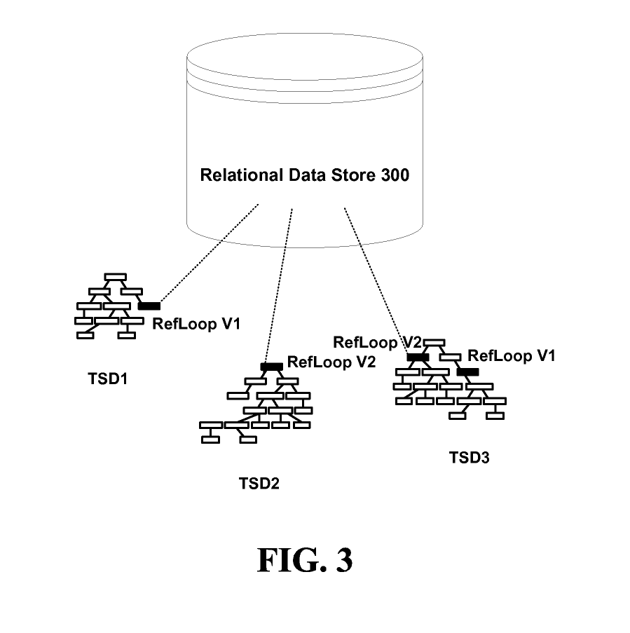

Thus, the invention enables versioning information for each copy of a building block as it changes and allows multiple versions to be used independently. Thus, with versioned EDI schema building blocks of the invention, it is possible to have a first TSD use the first version of a loop building block named RefLoop while a second TSD might use the second version of RefLoop. Indeed, with versioned EDI schema building blocks, a single TSD can separately use both the first and second versions of RefLoop. This situation is illustrated in the data dictionary of the invention stored in relational data store 300 of FIG. 3 wherein RefLoop V1 is used in TSD1 and TSD3, and RefLoop V2 is used in TSD2 and TSD3.

In this regard, the invention supports versioning for two kinds of changes to a Schema: a change to a property and a change to the structure. For instance, a change to a property might be a change to the minimum number of occurrences, the maximum number of occurrences, or the name of the property. A change to the structure of the Schema might include insertion of a new child element, moving an existing child element from one position in the Schema to another, rearranging Loop order, etc.

Accordingly, as described above in various non-limiting embodiments, the invention enables the storage of EDI Data dictionary elements and their versioning. In various non-limiting embodiments, each element is treated as an object that can be saved and recreated from its saved version. All changes to an object are tracked by a unique identifier, called a changeList. In one non-limiting implementation, a single changeList can modify multiple objects.

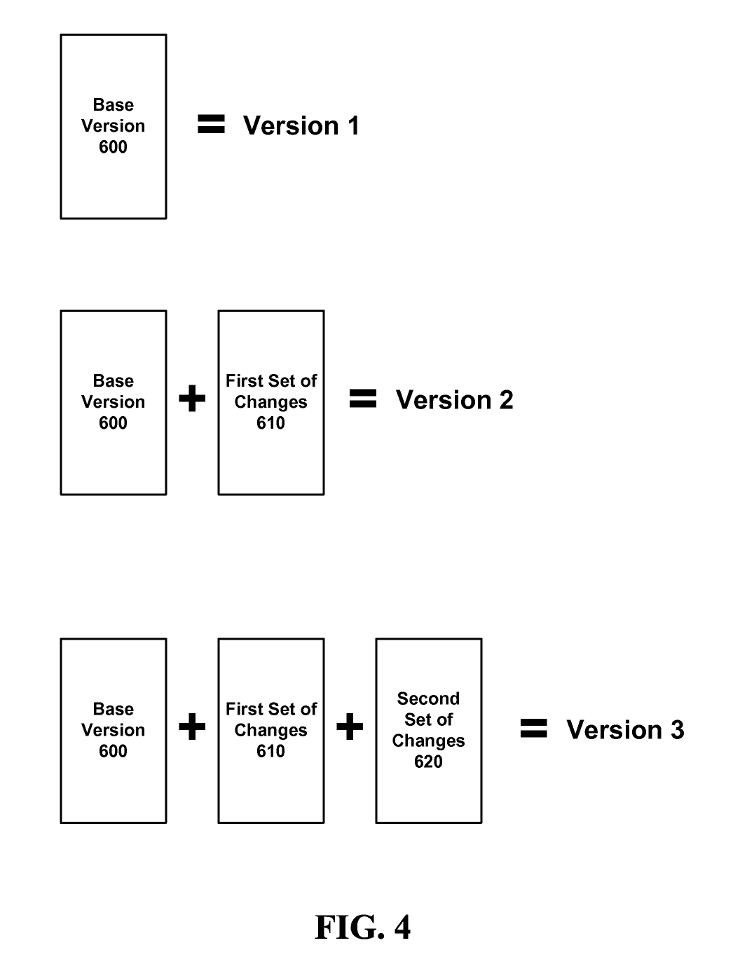

As shown in exemplary fashion in FIG. 4, in one embodiment, a version is reconstructed by starting with the first version 400, and then adding on changes 410 to get to the second version, and then additionally enacting changes 420 to get to the third version, and so on.

Each object thus has an associated version number. In an exemplary, non-limiting embodiment of the invention, when an object is created the first time, it is given a version number of 1. All subsequent changes to the object are saved in the system as differencing information, i.e., the nature of changes is saved in the system as opposed to saving a new copy of the entire object. This results in efficient storage. Otherwise, over a period of time, when hundreds of versions of an object exist, there would be too much duplication of the same EDI building block information.

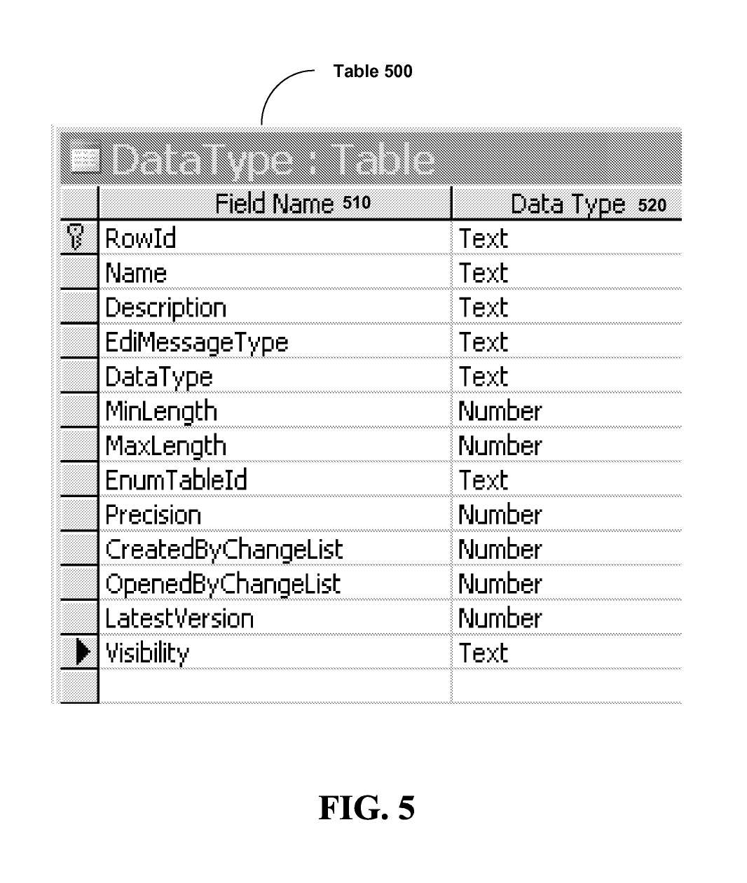

As mentioned, in accordance with the invention, the objects, i.e., the EDI schema building blocks, can be stored in relational format. An exemplary table structure 500 representing such objects is displayed partially in FIG. 5 having Field Names 510 and associated Data Types 520. Each data type 520 has a name 510. Other columns might include optional descriptions, EdiMessageType, etc. The fields additionally stored in accordance with the invention include the following fields to support one or more aspects of the versioning described above:

CreatedByChangeList—the change list number that created this object

OpenedByChangeList—whether this object is currently being edited or not

LatestVersion—the latest version of this object

In an exemplary, non-limiting embodiment of the invention, all objects that can be versioned share the above three attributes while their other properties are object specific. For instance, a DataType and SimpleField object share the above three attributes, but differ in other properties.

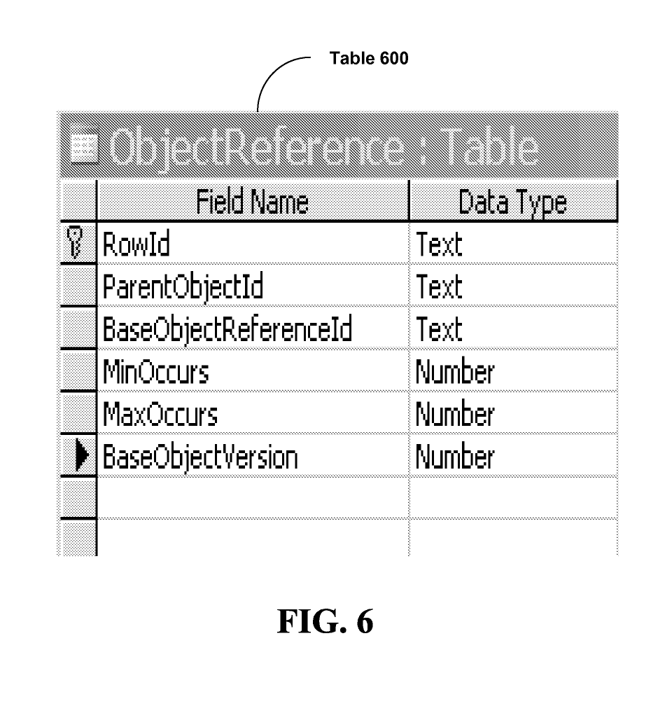

With respect to object references, an object can be used in various places in accordance with the invention. Thus, a Segment can be reused by a Loop or another TSD. Whenever an object is used, a reference is made to it, which is then stored in a table such as the object reference table 600 represented in FIG. 6. Each use of an object points to the identifier of the base object along with its version.

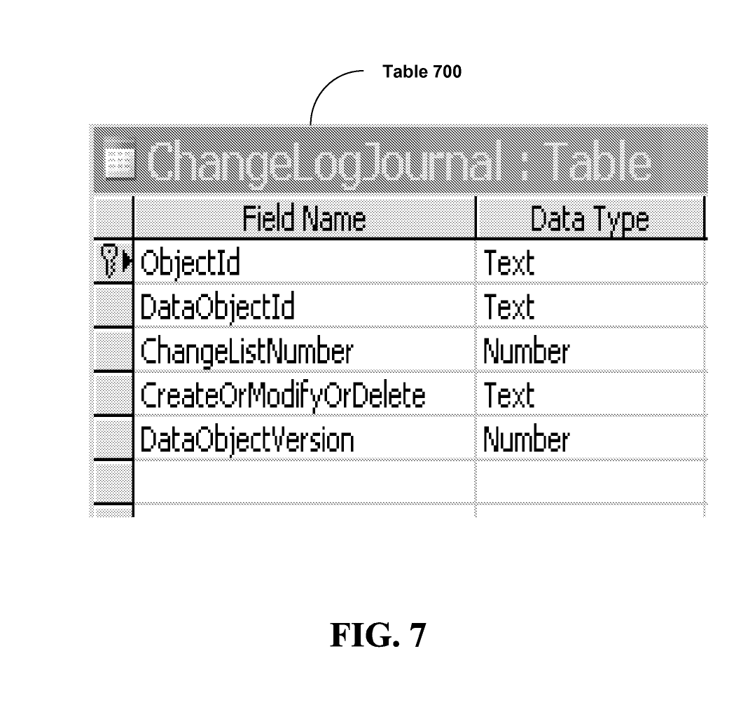

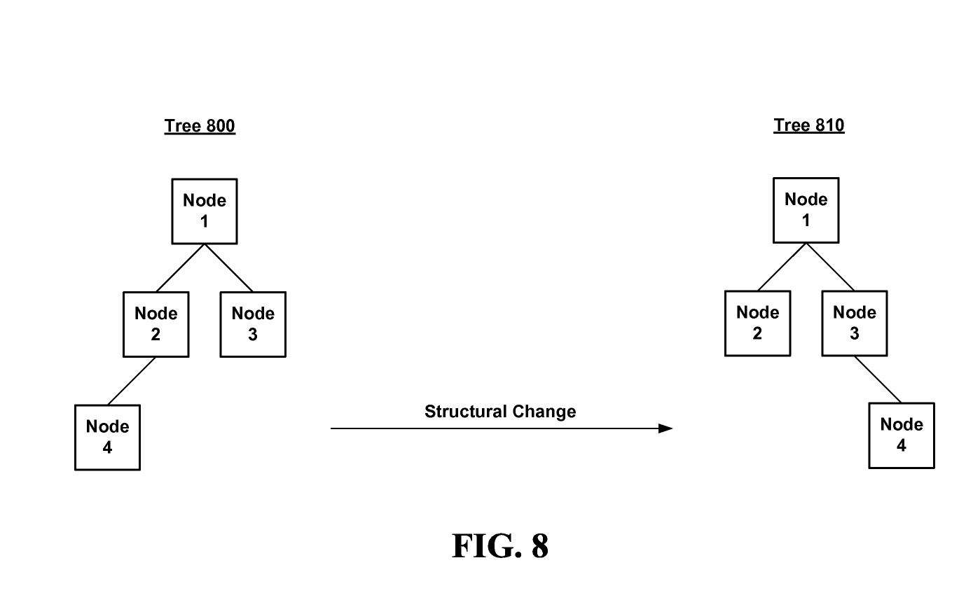

A change log can modify multiple objects. All the objects modified by a changeList are contained in a changeLogJournal. Exemplary structure for a Change Log Journal table 700 is displayed in FIG. 7. Table 700 captures the object identifier of the object, the changeList number that caused the change and the new version of the object. In addition, each change indicates the type of operation performed on an object. In one embodiment, this includes: Creation of an object, Modification of an object and Deletion of an object.

In another exemplary, non-limiting aspect, the invention enables extraction of reusable pieces from an XML schema through structural equivalence analysis. It can be appreciated that modeling EDI payloads as XML data has a lot of benefits. However, using XML schemas requires lot of skill and expertise. Thus, the dictionary system of the present invention has the native capability to generate XML schema from TSDs stored in a relational system according to the above-described techniques. Consequently, users are advantageously freed to deal with TSDs that are much easier to understand than XML schemas, which include a lot of extra information and formatting beyond EDI Data in order to adhere to XML rules.

In addition to being able to natively generate an XML schema from an EDI schema stored according to the invention, users can import external XML schemas into the dictionary system of the invention. During the import process, the XML schema is parsed and broken into smaller pieces like data types, simple elements, composite elements, etc., e.g., as described above for FIG. 1. For each of these building blocks, the system compares the structure of the building blocks with the ones already existing in the relational data store. If the document received represents a version of an existing schema, the difference analysis tool of the invention can be used to display the differences between the received EDI schema and another version of that EDI schema in the data dictionary.

### Difference Analysis for EDI Data Dictionary

In other exemplary, non-limiting aspects of the invention, a user friendly data dictionary editor is provided that performs differencing analysis on the tree-based structures stored in an EDI data dictionary as described above. In this respect, XML schemas are difficult to use and manipulate. Although an EDI payload can be modeled around XML schemas, only a small fraction of XML schema constructs are relevant for EDI data. Thus, in accordance with the invention, a TSD editor is provided that can abstract away from the XML schema constructs, and hide them from the user, while presenting only the relevant EDI constructs. For the changes determined between two versions of the same schema, only the changes to the relevant nodes of the EDI schema tree structures are displayed to the user.

As described in detail above, each EDI message type has an associated TSD, which is composed of smaller building blocks like Loops, Segments, Composites, Simple Fields and Data Types. These building blocks (also called EDI schema elements, TSD elements, dictionary elements, objects, tree nodes, etc.) can be used from a dictionary of global definitions. Typically, there are thousands of elements in the dictionary and they undergo changes over time to reflect changing trading partner agreements. Accordingly, a tree based difference analysis tool is provided that eliminates the need for guesswork and other shortcomings of line based systems and offers an exact and precise rendition of changes. Differences are tracked in terms of higher level user constructs that map to EDI schema elements, which greatly simplifies analysis of differences in schema by a user. These differences are further represented as to whether a given difference is a change to a property of a tree element (e.g., by changing the maximum value for a given property), or whether the given difference is a change to the structure of the tree itself (e.g., by moving a node's relationships to other nodes).

Also, in another non-limiting aspect, the “Move” command is treated as a first class command as opposed to a “Cut and Paste,” since cut and paste can sometimes create confusion to users. This is because cut and paste can be thought of as two conceptual actions, (1) a cut, remove or delete action and (2) a paste, add or copy action. Two actions can be confusing as to whether both actions go together or whether they were intended separately, whereas move (a single conceptual action) removes any ambiguity whether they were intended together.

As mentioned above in connection with FIG. 4, in one embodiment, for efficient storage and exact reconstruction of different versions, the invention maintains one master copy of data and all tracks changes over the data as distinct operations over data.

Thus, as the dictionary elements change over time, it is important to have a tool to offer a picture of the changes, in order to have an understanding of how existing versions differ from prior versions.

With current difference analysis tools, as discussed in the background, TSDs are usually represented in the form of XML schemas. Any changes to TSDs result in changes to one or more lines of the XML schema (XSD) file. People then use generic differencing tools to analyze the changes. However, these are line based tools that have no notion of hierarchy and thus cannot appreciate the compositional elements of the EDI schema tree structure represented by the XSD. In this regard, TSDs are hierarchical entities and using line based tools to track changes is thus not a good choice.

Recognizing that an EDI data dictionary includes items that are hierarchical in nature, like Loops, Segments, Composites, etc. and that each element includes properties and a list of children (which can contain other children, and so forth), the invention provides a hierarchical difference analysis tool for an EDI data dictionary. In this regard, the invention provides a data dictionary editor is provided that understands the hierarchical nature of TSDs, and which also hides the complexity of any underlying type system representing the EDI schema, such as may be present in an XSD. Given a starting document, time, or version, the tool displays changes made to any TSD, or any other constituents of the EDI data dictionary.

As alluded to above, there are broadly two types of changes, commands, operations, etc. that can be applied to an object: (1) Property changes and (2) Structural changes. Property changes alter the properties associated with an object, but not its hierarchical state. In various embodiments, any of the following types of property changes are supported:

NameEdit—Change to the name of an object

DescriptionEdit—Change to user comments associated with an object

MinOccursEdit—Change in minimum occurs cardinality value

MaxOccursEdit—Change in maximum occurs cardinality value

DataTypeNameEdit—Change in name of data type

MinLengthEdit—Change in minimum length of a field

MaxLengthEdit—Change in maximum length of a field

TableEntryAdd—When an entry is added to a list of allowed values

TableEntryRemove—When an entry is removed from a list of allowed values

Structural changes instead alter the position of an object within the overall hierarchy. A structural change is shown as the change from hierarchical tree 800 to hierarchical tree 810, wherein node 4 has been moved from parent node 2 to parent node 3. The list of children for nodes 2 and 3 both change as a result. In various embodiments, any of the following types of structural changes are supported:

InsertChild—When a new child is added to an object

RemoveChild—When an existing child is removed from an object

MoveChild—When a child is moved from one position to the other for the same parent

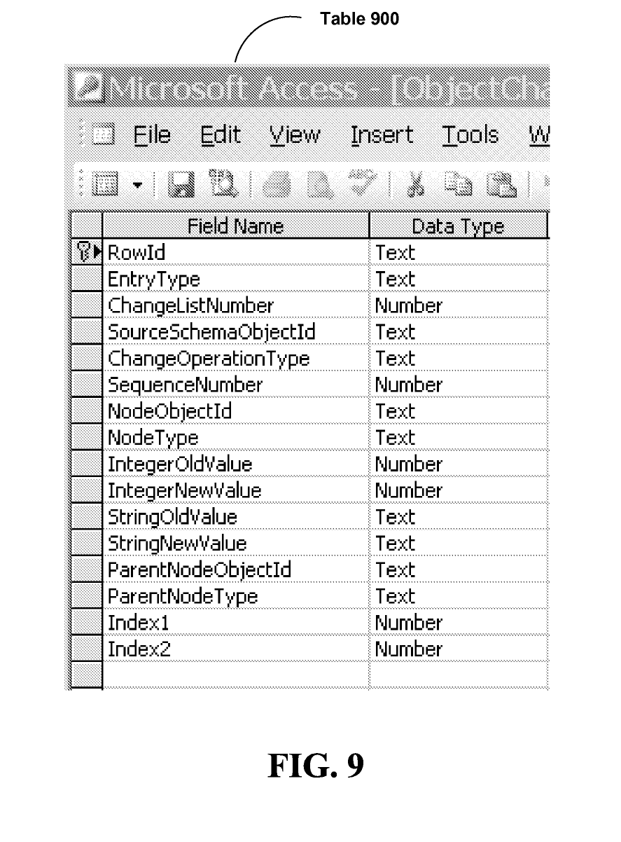

The system tracks all changes made to an object, such as the object represented in shown in Table 900 of FIG. 9 in terms of the types of the above changes. At any point in time, including opportunities around changes, users can ask the system to label an object with the next higher version. At any point in time, users can see a history of different versions and recreate each version of the object. In addition, they can open any two versions of an object and look at the differences.

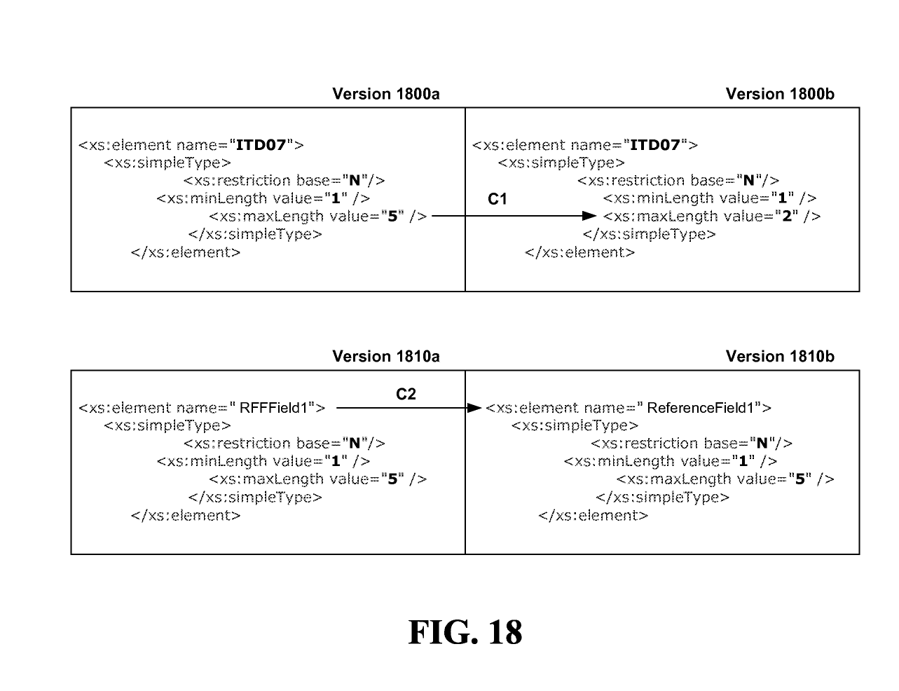

The differences are rendered in simple terms to make it easier to analyze changes. Thus, instead of XML script representing an underlying TSD, users see changes like: “Minimum length of a field has changed from 5 to 2” or “the name of an object has changed from RFFField1 to ReferenceField1.” This is in contrast to the side by side XML versions of FIG. 18 presented in the background, which are difficult to read even for someone with XML schema expertise.

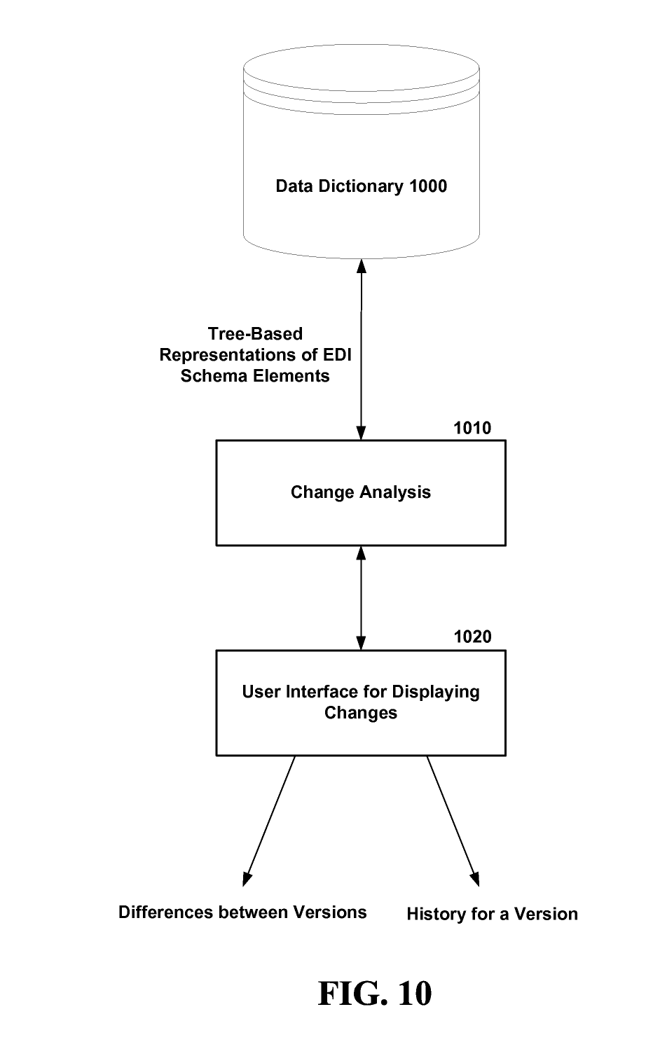

FIG. 10 is a block diagram illustrating that an exemplary non-limiting embodiment of a change analysis component 1010 that interacts with tree-based representations of the EDI building blocks in an EDI data dictionary 1000. The change analysis component 1010 can be accessed by a user via user interface 1020, which displays changes determined by the change analysis component 1010. For instance, via user interface 1020, a user may request different schema versions to be displayed to see the differences between the versions, or may request the change history for a particular version selected. The versions displayed are further editable based on the EDI building blocks such that the change history of any EDI building blocks that are edited is captured by the system, such that additional versions may be created based on the editing.

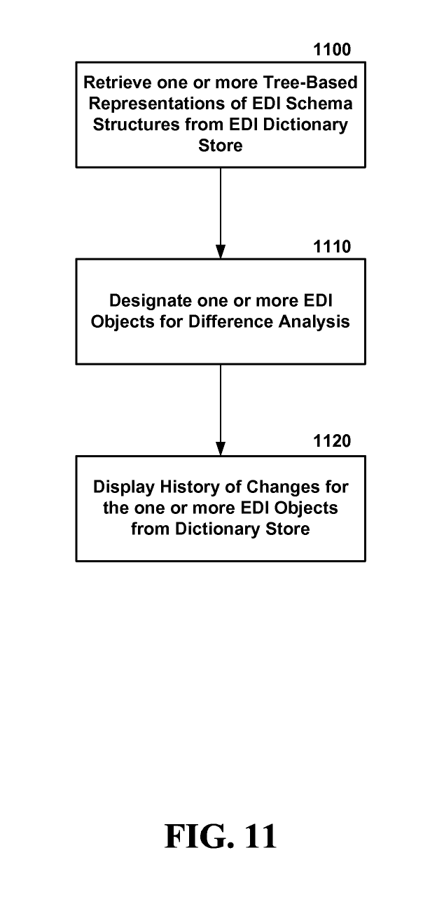

The flow diagram of FIG. 11 illustrates an exemplary, non-limiting process for displaying change histories for a version of an EDI schema. At 1100, one or more tree-based representations of EDI schema structures are retrieved from an EDI dictionary store. At 1110, one or more (or all) of the EDI Objects of a designated tree-based representation of an EDI schema structure can be selected for differencing analysis. At 1120, after consultation with the appropriate change tables of the dictionary store, the history of changes can be displayed for the selected EDI Object(s). The history of changes is displayed in a way that makes sense for the EDI Object(s) affected by the change, without displaying additional wrappers over the EDI Object(s) that may be introduced by an XSD representation, or the like.

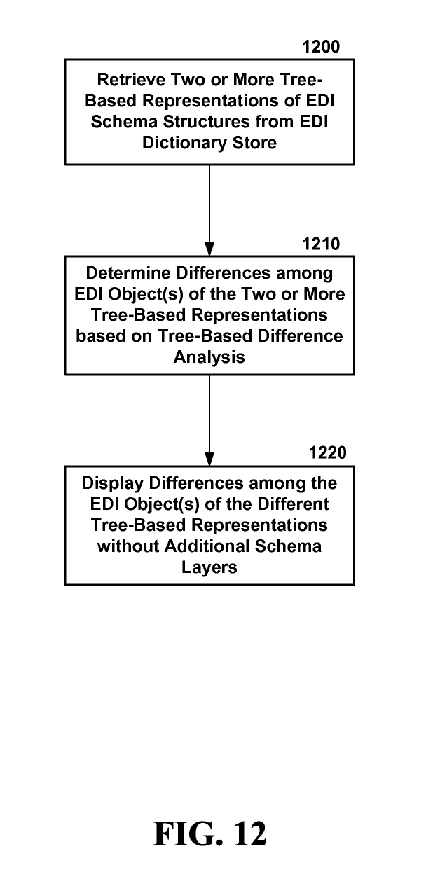

As illustrated in the flow diagram of FIG. 12, for an exemplary process for comparing versions to quickly determine the differences in EDI schema, at 1200, two or more tree-based representations of EDI schema structures are retrieved from the EDI dictionary store. At 1210, the differences are determined among EDI Object(s) of the two or more tree-based representations based on tree-based differencing analysis of the EDI Object(s). Then, exemplary user interface may be used to display the differences among the EDI Object(s) of the different tree-based representations in a simple fashion based on the EDI Object(s) themselves. As with change history, the differences can be displayed without displaying additional wrappers over the EDI Object(s) that may be introduced by an XSD representation, or the like. Thus, the differences between two versions are easily ascertainable.

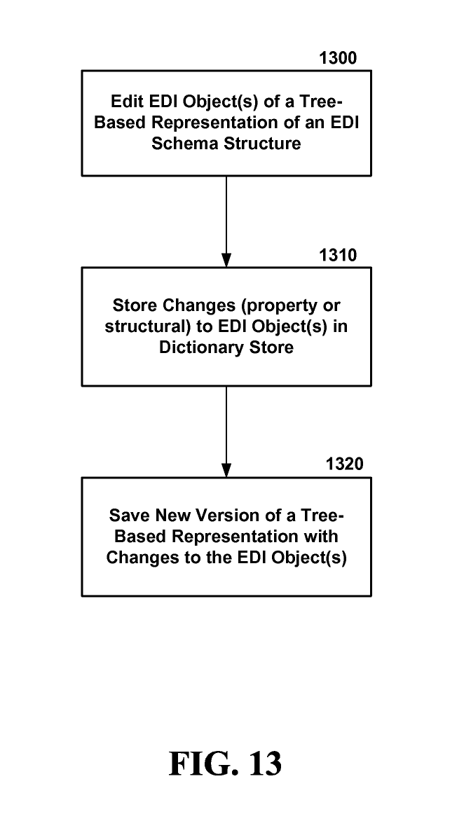

FIG. 13 further illustrates an exemplary process of editing one or more EDI object(s) to create a new version of an EDI schema. At 1300, a user edits EDI Object(s) of a designated tree-based representation of an EDI schema structure on display. At 1310, those changes are stored in the dictionary store. If, at 1320, a user saves a new version based on the changes, the new version can then be redisplayed with the tools of the invention, along with its change history, showing the changes to the EDI elements with native EDI understanding.

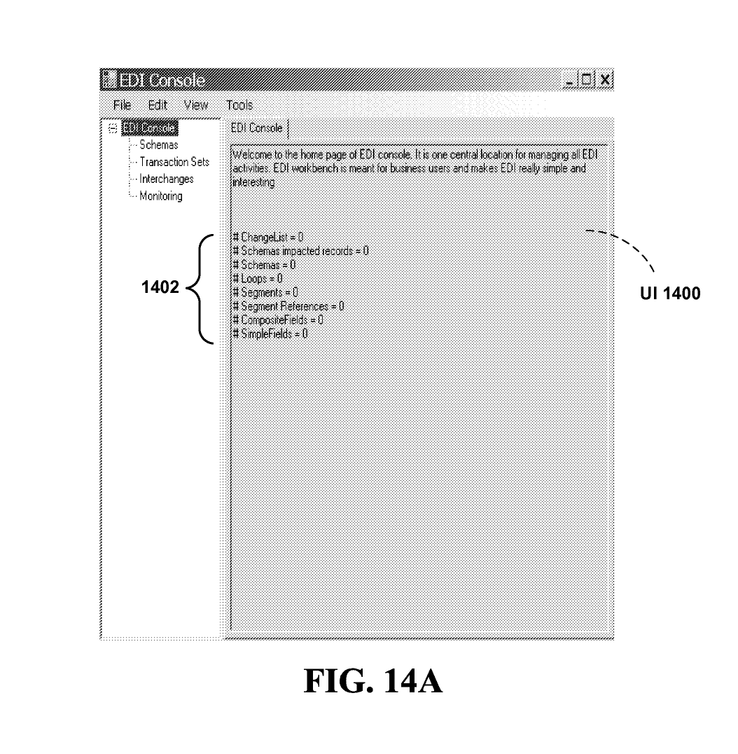

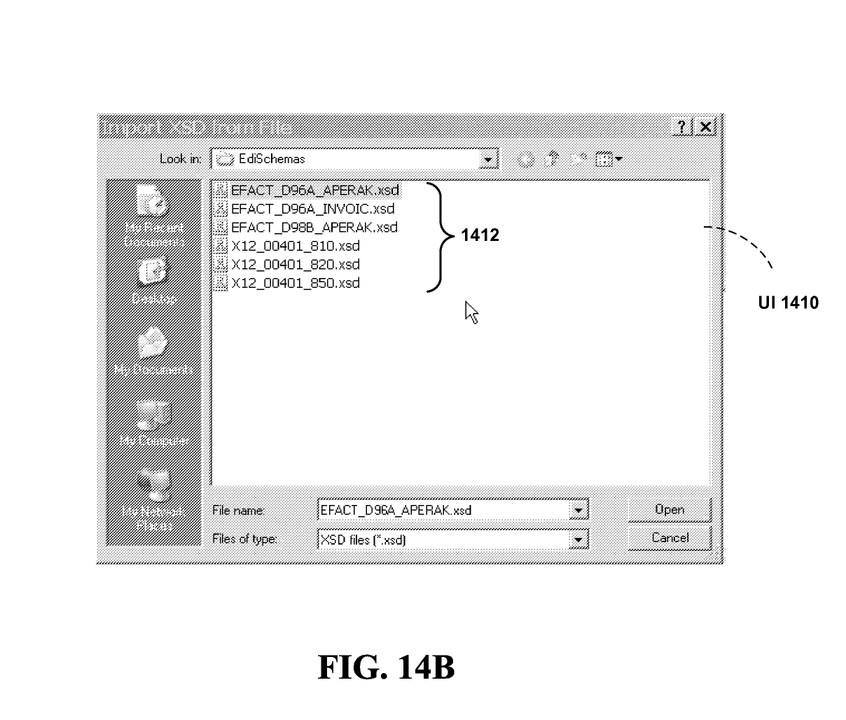

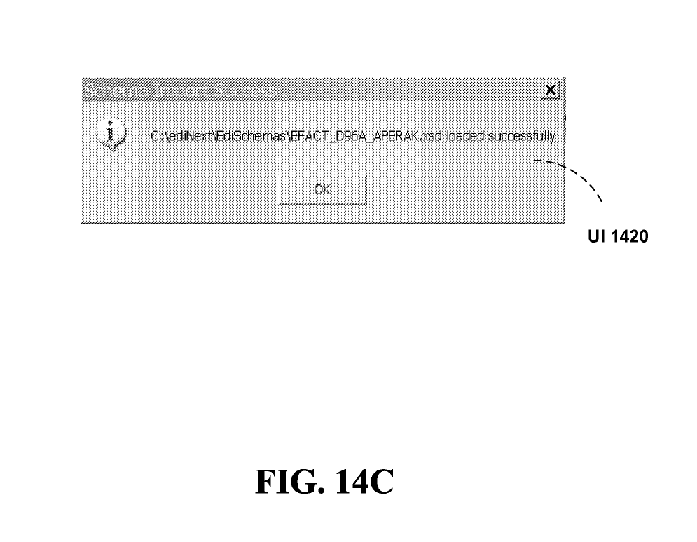

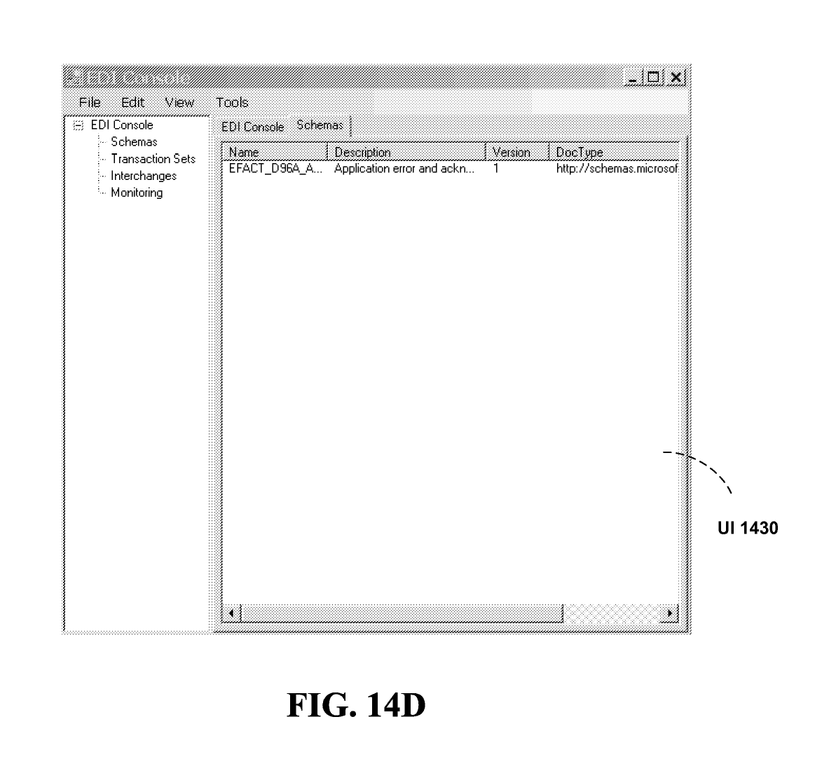

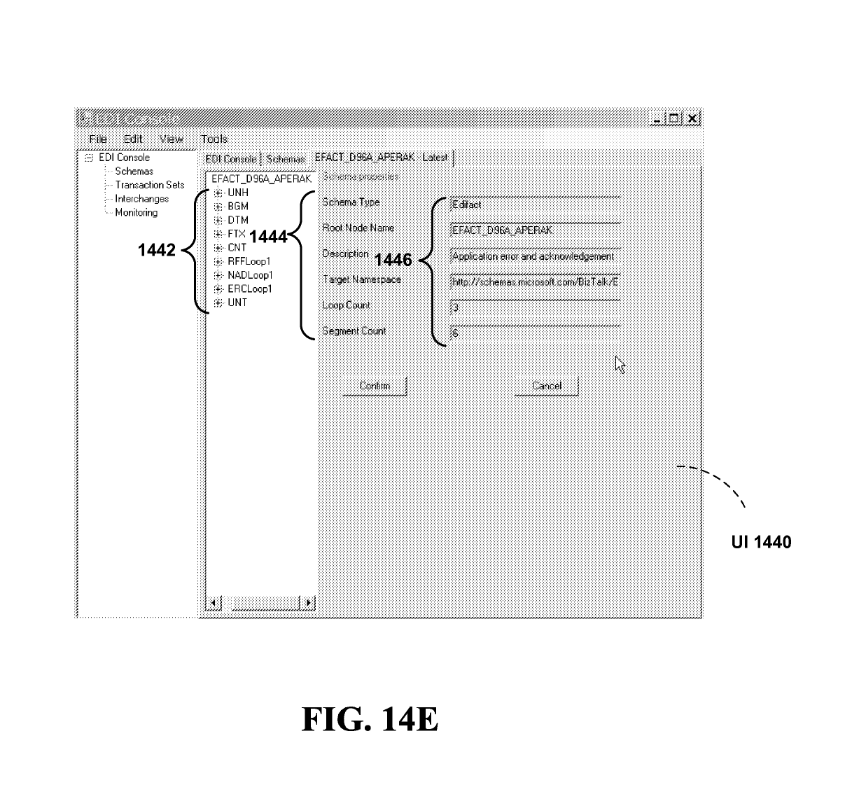

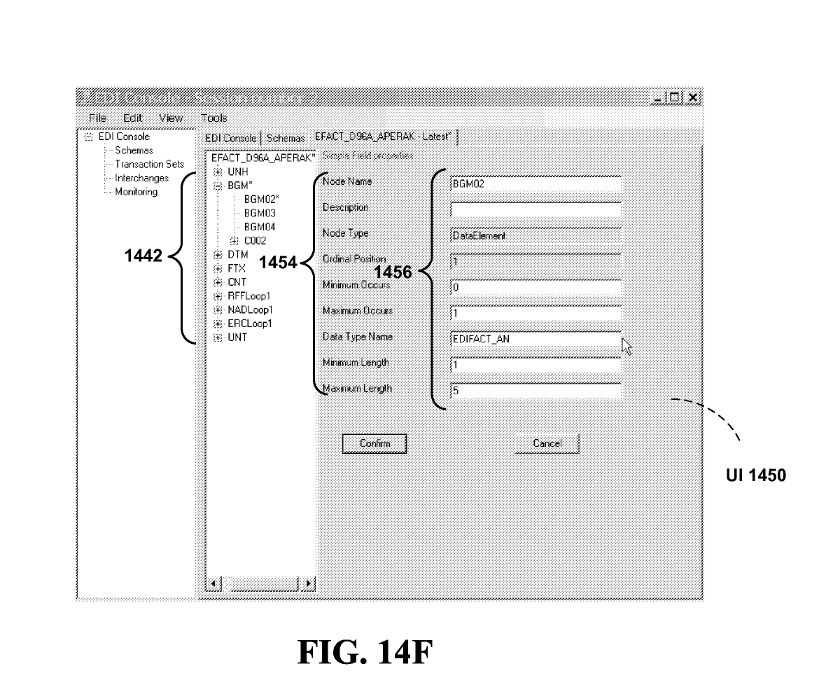

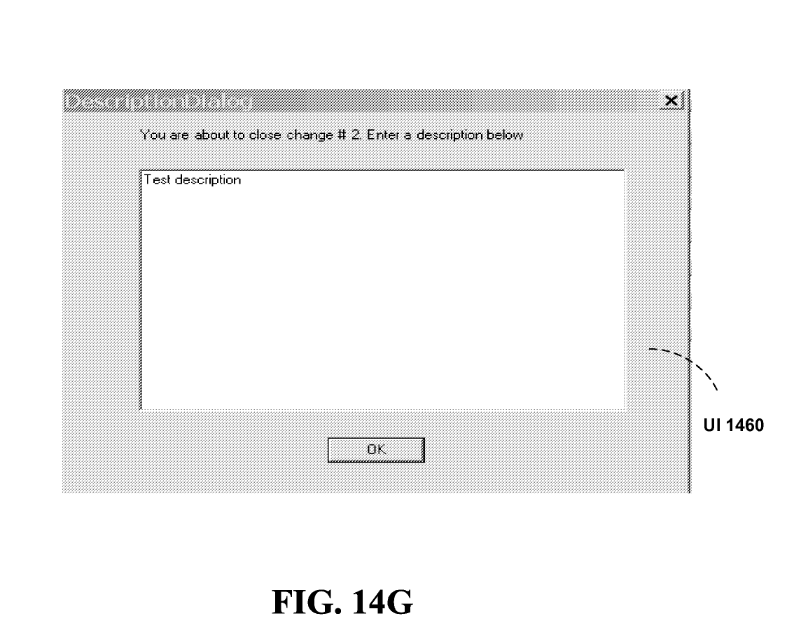

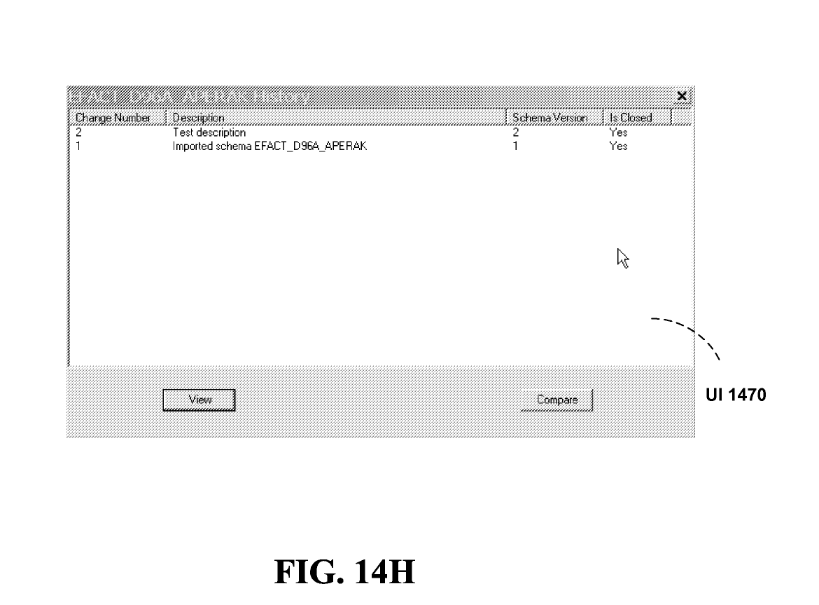

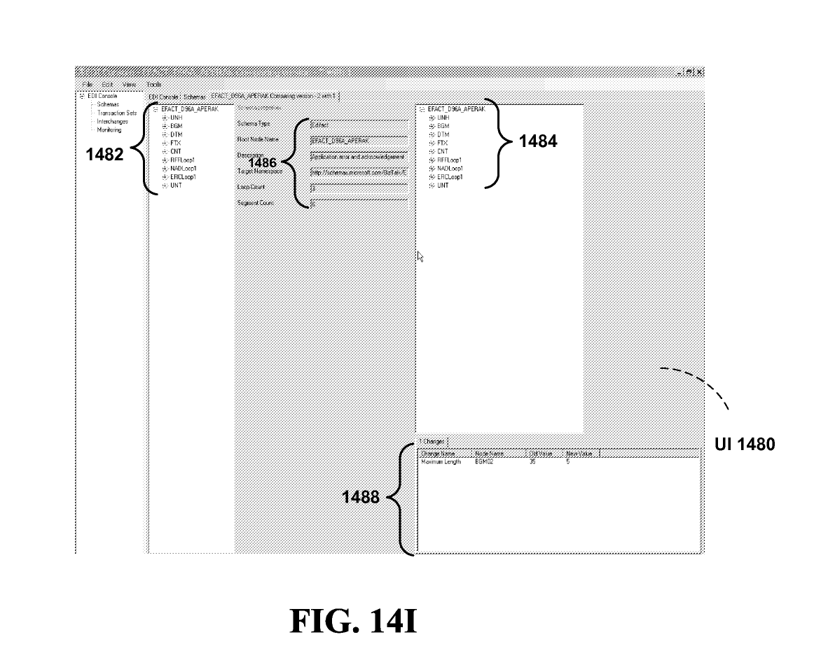

The screenshots of FIGS. 14A to 141 illustrate an exemplary interaction with non-limiting user interface (UI) as represented by a sequence of screenshots in order to open, edit and save a new version of a schema, and then compare the new version to the original version simply and easily using the change analysis tools of the invention. For instance, screenshot 1400 of FIG. 14A illustrates an exemplary home screen without any schema represented at portion 1402, which shows the absence of a schema. Via UI 1410 of FIG. 14B, any one of schemas 1412 can be selected via a file system, which is confirmed optionally via UI 1420 of FIG. 14C. Once opened (imported), as shown in UI 1430 of FIG. 14D, some basic information about the schema is displayed, e.g., name, description, version and data type. In this respect, it is noted that the schema opened is the first version of the schema.

UI 1440 of FIG. 14E illustrates a closer look at the schema opened in FIG. 14D. UI 1440 includes a portion 1442 that shows the actual tree-structure of the EDI schema (shown unexpanded). Portion 1444 shows a list of properties for the EDI schema and portion 1446 shows a list of corresponding property values for the EDI schema. UI 1450 of FIG. 14F shows the expansion of the tree structure of portion 1442 to an element, or object BGM02. Portion 1454 shows a list of properties for the element BGM02, and portion 1456 shows a list of editable values for the properties. Editing one of the values, e.g., assuming the value for Maximum Length was changed to ‘5’ from the value ‘35’ as shown in FIG. 14F, and then saving the changes, results in a request to associate a description for the change as shown by exemplary UI 1460.

The change history for schema object is then captured in the change history associated with the schema objects, which can then be displayed via exemplary UI 1470 of FIG. 14H as a list comprising the change history for the schema all the back to the first version of the schema. It is noted that any XSD or other file format for representing the EDI elements of an EDI TSD is hidden from the user of the tool so that the tool works on the level of the EDI elements without any additional complexity for the user.

Finally, the output of the difference analysis component of the invention can be observed on display in exemplary UI 1480 of FIG. 14I. The two tree-based structures, i.e., the first version of the schema, and the second version of the schema created when the Maximum Length property was changed from 35 to 5, displayed in portions 1482 and 1484, respectively, for a visual compare of the EDI objects as a tree. Portion 1486 shows the various schema properties of the second version, and portion 1488 displays the changes that occurred from the first version to produce the second version. For instance, portion 1488 states in a simple fashion that Maximum Length for Node BGM02 of the tree structure was changed from 35 to 5. In one embodiment of the invention, the nodes that have been affected by change are highlighted, or otherwise marked, to distinguish from nodes that are the same between the schema. In this fashion, a user can quickly determine what the relevant differences are among versions of a schema, or otherwise view the change history of any schema in the dictionary store.

### Supplemental Context Regarding EDI Messaging Systems

EDI is the exchange of structured information, by agreed upon messaging standards, from one computer or computer application to another by electronic means with minimal human intervention. Based on approved formatting standards and schemas, EDI is one of the ways businesses exchange computer-to-computer business information. For example, millions of companies around the world transmit and store data associated with business transactions (e.g., purchase orders, shipping/air bills, invoices, or the like) using EDI to conduct commerce.

EDI may thus be defined as computer-to-computer exchange of business information using ‘approved’ formatting standards, referring to specific interchange methods agreed upon by national or international standards bodies for the transfer of business transaction data. One typical application for EDI messaging is the automated purchase of goods and services, though EDI messages are by no means limited to any particular kind of business data. In this regard, millions of companies around the world use EDI to conduct commerce. In raw format, EDI data is transmitted as delimited files (without self describing tags) and therefore the encoding rules enforce very strict formatting rules to ensure the destination application is able to successfully parse and consume the information for down stream processing.

Organizations that send or receive documents from each other are referred to as “trading partners” in EDI terminology. The trading partners agree on the specific information to be transmitted and how it should be used. Service providers provide global platforms (also known as trading grids) to connect and integrate “business partners” around the world. They provide integration platforms that make the exchange of EDI (or XML) documents transparent and easy between diverse constituents. These providers also track and reconcile documents to reduce errors and improve supply chain performance.

EDI translation software provides the interface between the internal system and the common standards and applies to both “inbound” documents and “outbound” documents. Translation software may also utilize other methods or file formats translated to or from EDI.

It can be appreciated by those of skill in the art that the structured information of EDI files can also be represented with the extensible markup language (XML), and vice versa. Despite the use of EDI being somewhat unheralded relative to its counterpart XML, EDI files are still the data format used in a majority of electronic commerce transactions in the world.

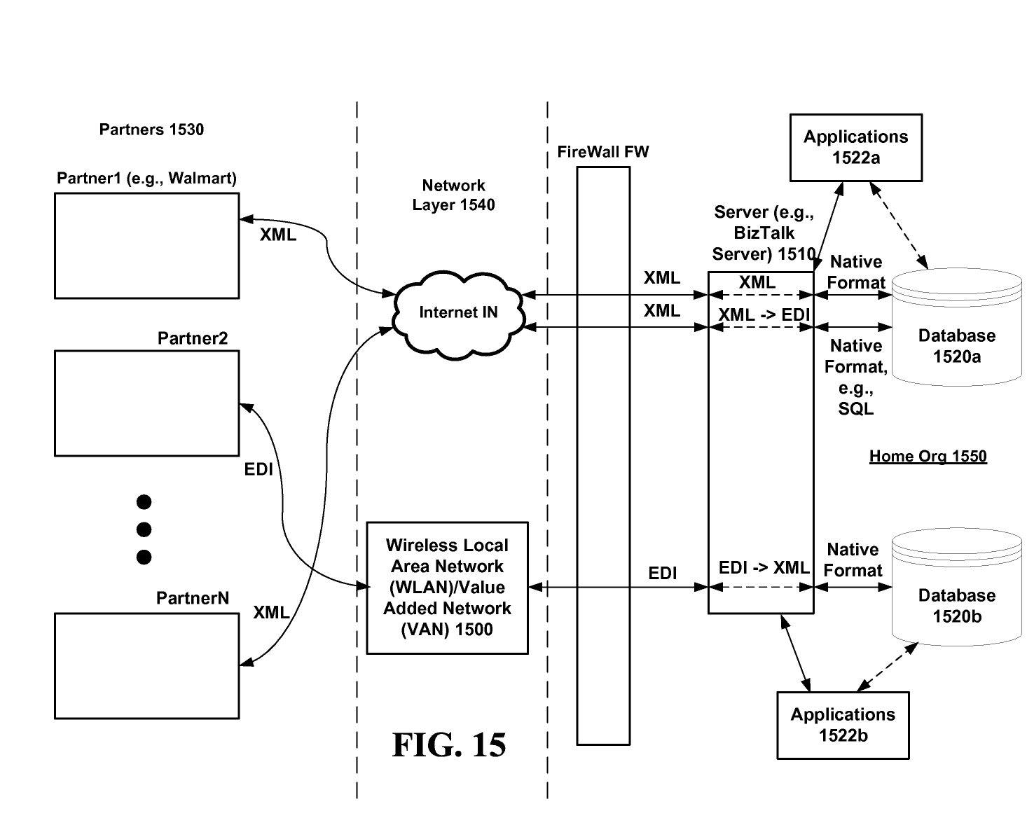

In the exemplary EDI system for a home organization 1550 shown in FIG. 15, typically server software, such as Microsoft's BizTalk Server 1510 can be deployed to interact outside of the home organization 1550 via network layer 1540 and to interface with databases 1520a, 1520b, etc. so that various applications 1522a, 1522b, etc., can interact with the automated storage of business records received by databases 1520a, 1520b, etc. EDI files or XML representations of EDI files can be received via Internet IN, or a wireless local area network (WLAN) or value added network (VAN) 1500 of network layer 1540, e.g., through firewall FW, and such EDI/XML messages can be received from any of a variety of trading partners 1530, i.e., partner1, partner2, . . . , partnerN. Server 1510 can handle any of the necessary conversions and parsing of EDI files or XML representations thereof, and any conversions to or from a native database format, such as SQL.

Typically, when an EDI messages are received, a server receiving the EDI messages can answer in terms of an acknowledgment of receipt of the EDI messages to its trading partner. The server will specify whether the EDI message is invalid according to the schema, and if invalid, will specify why, or the server will specify that the EDI message was accepted, accepted with errors or rejected.

Internet IN has enabled EDI transactions to be transmitted between trading partners in an even more efficient manner. Internet IN provides business and government agencies with an environment that is open, fast, cost effective, and widely accepted and used.

VAN 1500 is a mechanism that facilitates the transfer of electronic data between trading partners. A VAN 1500 can be thought of as a post office, or a dedicated pipe, that allows an entity to send EDI formatted data to one of their trading partners at any time. The VAN 1500 will hold the file of transmitted transactions until the trading partner to whom it is addressed retrieves it at a later time.

The EDI standards were designed to be independent of lower level technologies and can be transmitted using Internet protocols, such as the file transfer protocol (FTP), telnet and email, as well as private networks, such as value-added networks (VANs). EDI documents contain the same data that would normally be found in a paper document used for the same organizational function. For example, an EDI ship-from-warehouse order might be used by a manufacturer to tell a warehouse to ship product(s) to a retailer. It typically has a ship to address, bill to address, a list of product numbers (e.g., a UPC code) and quantities. It may also have other information if the parties agree to include it. However, EDI is not confined to just business data directly related to trade, rather but encompasses all fields such as medicine (patient records, laboratory results, etc.), transport (container and modal information, etc.), engineering and construction, etc., i.e., anywhere a first entity may wish to automate the exchange of data with another entity.

In a typical EDI transaction model, a large business entity or an EDI integration broker trades with numerous partners and has the technical capability to handle numerous EDI transaction data in various EDI formats and schemas. These entities, also known as “hubs,” transact with one or more suppliers, also known as “spokes.” Each of the spokes typically is a relatively small business entity that is only capable of dealing with one hub.

Before the spokes attempt to initiate transactions via EDI with the hub, the hub typically transmits various EDI schemas to the spokes so that the spokes can properly format the EDI transactions according to the EDI schemas.

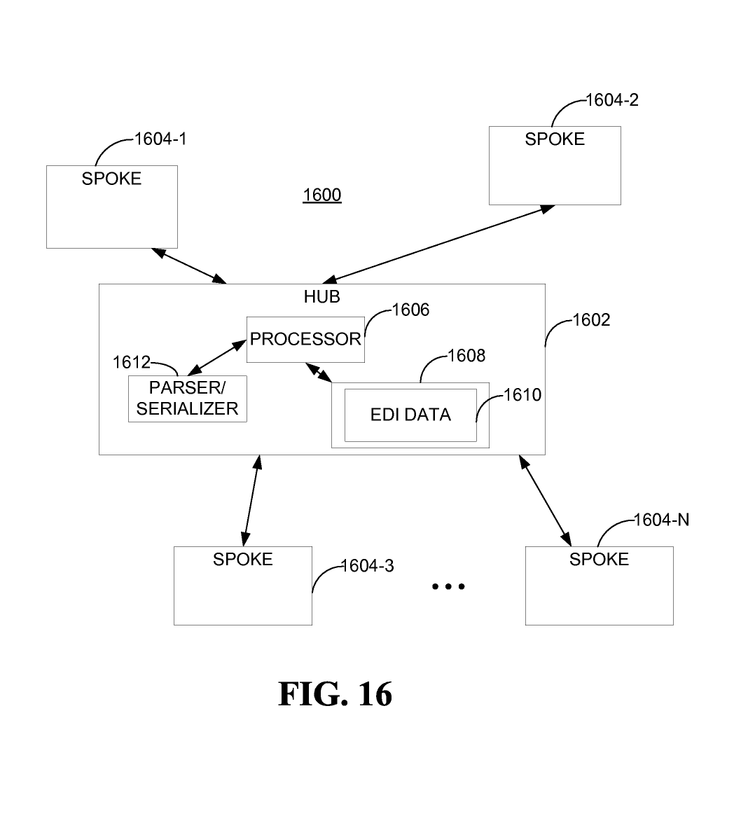

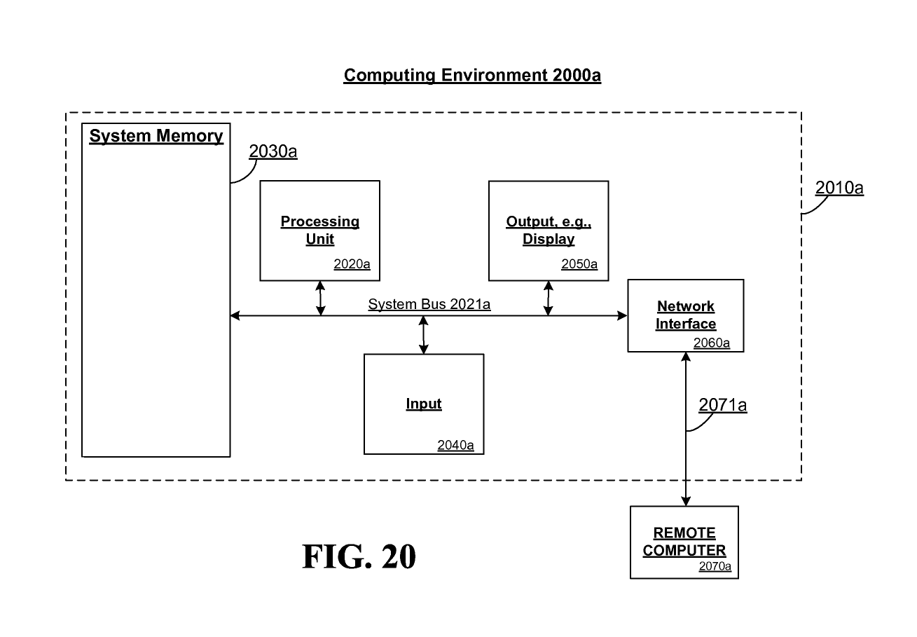

FIG. 16 is a block diagram illustrating a system for conducting EDI transactions according to exemplary non-limiting embodiments of the invention. A system 1600 is illustrated for conducting EDI transactions. System 1600 includes a hub 1602 linked to and communicating with one or more spokes (e.g., spokes 1604-1, 1604-2, 1604-3, . . . , 1604-N). In one embodiment, the hub 1602 includes a server computer or a computing device serving one or more processors (e.g., processor 1606) or processing units for executing computer-executable instructions for serving the spokes 1604. In one example, the spokes 1604 include a computing device having one or more components included in or coupled with a computer 1630, as shown in FIG. 20.

In one example, the hub 1602 also includes a memory area 1608 for storing one or more EDI schemas, such as an EDI schema 1610. Initially, the hub 1602 and the spokes 1604-1, 1604-2, 1604-3, . . . , 1604-N establish agreements as to the EDI formats or standards to be used for transmitting transaction data therebetween. Once the parties determine the particular EDI formats or standards to use, the hub 1602 selects the appropriate EDI schemas to be transmitted to the spokes 1604-1, 1604-2, 1604-3, . . . , 1604-N. In another example, the hub 1602 may choose to select all EDI schemas for all types of transactions, such as purchase orders, bills of lading, invoices, payrolls, or the like, to the spokes 1604-1, 1604-2, 1604-3, . . . , 1604-N.

Although the communications between the hub 1602 and the spokes 1604-1, 1604-2, 1604-3, . . . , 1604-N can be a private or public communications network, a wired or wireless network, the spokes 1604-1, 1604-2, 1604-3, . . . , 1604-N typically lack the hardware resources to handle large amount of EDI schemas sent from the hub 1602. In addition, the type and bandwidth of computing network communications for the spokes 1604-1, 1604-2, 1604-3, . . . , 1604-N are not equipped to handle such demand imposed by the thousands of EDI schemas, which can reach several Gigabytes in data size.

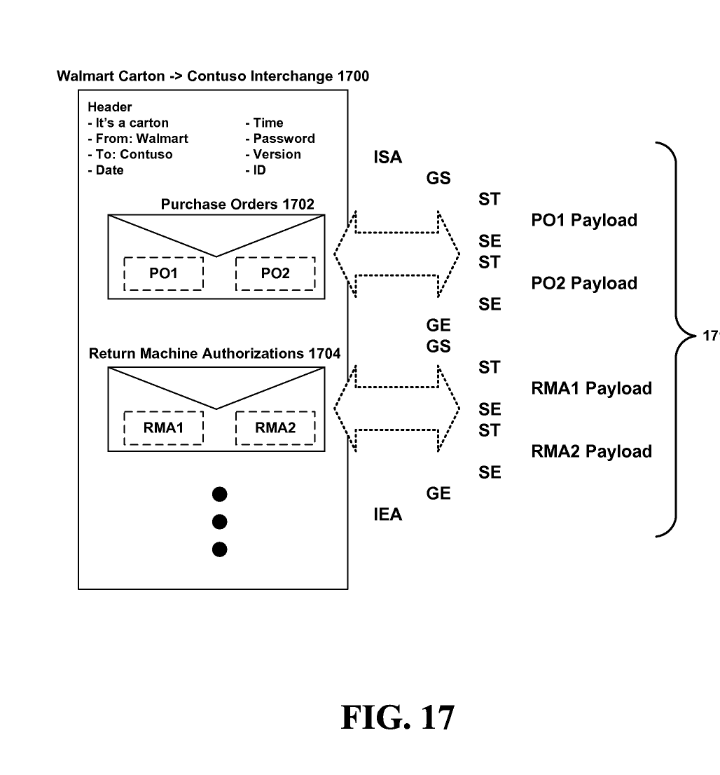

FIG. 17 in turn illustrates that an organization can generate an interchange 1700—a sort of carton for EDI messages—which includes a plurality of EDI messages. Interchange 1700 typically includes a header which includes a type of document, from whom the document originated, to whom the document is addressed, the date, the time, any password information, version information, identification information, and the like. Then the interchange 1700 lists a series of purchase orders 1702 and return machine authorizations (RMAs) 1704, conceptually shown as envelopes in the carton. In turn, each envelope conceptually represents one or more individual EDI files, or messages. For instance, purchase orders 1702 include individual purchase orders PO1 and PO2, and RMAs 1704 include RMAs RMA1 and RMA2, and so on.

In turn, there is a flat file native EDI format that corresponds to this conceptual relationship between carton->envelopes->messages. As illustrated by shell 1717 corresponding to the conceptual representation, the ISA <-> IEA indent level represents the beginning and end of the interchange (carton). The GS and GE indent levels represent the beginning and end of any envelopes within the carton, and the ST and SE indent levels represent the beginning and end of any messages within an envelope, i.e., inbetween any ST and SE will be an individual message payload, such as PO1 Payload, PO2 Payload, RMA1 Payload and RMA2 Payload.

There are several advantages of using EDI all of which provide distinct benefits to the user. One of the most notable benefits to using EDI is the time-saving capability it provides. By eliminating the process of distributing hard copies of information throughout the company, easy access to electronic data simplifies inter-department communication. Also, another time-savings advantage is the ability to track the origin of all information therefore significantly reducing time spent on corresponding with the source of the information.

Another benefit for the user of this information system is the ultimate savings in costs for an organization. Although the initial set-up costs may seem high, the overall savings received in the long run ensures its value. For any business, regardless of its size, hard-copy print outs and document shipping costs add up. EDI allows for a paper-less exchange of information reducing handling costs and worker productivity that is involved with the organization of paper documents.

EDI has another strong advantage over paper-based information exchange, which has to do with accuracy of information. When the information is already stored electronically, it speeds up an organizations ability to check for accuracy and make any necessary corrections as the data is already input to the system. Also, unlike paper-based methods, EDI allows for the ability to send and receive information at any time thereby tremendously improving an organizations ability to communicate quickly and efficiently.

A disadvantage of using EDI involves the initial set-up. The preliminary expenses and time that arise from the implementation, customization and training can be costly. However, as EDI systems continue to improve, such as by using the batching membership evaluation techniques of the invention, such disadvantage is disappearing as ease of use increase.

### Edifact and X12 Standards for EDI Documents

There are two major sets of EDI standards which can be used to generate and receive/process EDI messages: the United Nations Electronic Data Interchange for Administration, Commerce and Transport, which is a translation of UN/EDIFACT (“EDIFACT”) and the American National Standards Institute's (ANSI) Accredited Standards Committee (ASC) X12 (“X12”). Both used worldwide, X12 tends to be more popular in North America than EDIFACT. These standards prescribe the formats, character sets, and data elements used in the exchange of documents and forms, such as invoices and purchase orders, e.g., purchase orders are called “ORDERS” in EDIFACT and “850s” in X12.

Whichever selected, the standard dictates which pieces of information are mandatory for a particular document, which pieces are optional and gives the rules for the structure of the document. In this regard, with optional pieces, two EDI documents can follow the same standard and contain different sets of information. For example, a food company might indicate a particular product expiration date while a clothing manufacturer might choose to send color and size information.

For illustrative purposes only, the following is an example EDIFACT message, for instance, that might be used to answer to a product availability request:

UNB+IATB:1+6XPPC+LHPPC+VV40101:0VV50+1′

UNH+1+PAORES:VV3:1:1A′

MSG+1:45′

IFT+3+?*XYZCOMPANY AVAILABILITY?*′

ERC+A7V:1:AMD′

IFT+3+NO MORE FLIGHTS′

ODI′

TVL+2404VV3:1000::1220+FRA+JFK+DL+400+C′

PDI++C:3+Y::3+F::1′

APD+74C:0:::6++++++6X′

TVL+2404VV3:1740::2030+JFK+MIA+DL+081+C′

PDI++C:4′

APD+EM2:0:1630::6+++++++DA′

UNT+13+1′

UNZ+1+1′

wherein the following symbols have the following meanings:

′ is a segment terminator;

+ is a data element separator;

: is a component data element separator;

* is a repetition separator; and

? is a release character.

To explain the information contained in some of the above segments, the segment of the above exemplary EDI file designated by “UNH+1+PAORES:VV3:1:IA′” is the header segment. A header segment is required at the start of every EDI message. With this particular file segment, the message name and version is specified as PAORES VV3 revision 1 and it was defined by the organization IATA. The segment of the above exemplary EDI file designated by “IFT+3+NO MORE FLIGHTS′” is an ‘Interactive Free Text’ segment containing the text ‘NO MORE FLIGHTS.’ The segment of the above exemplary EDI file designated by “UNT+13+1′” is the tail segment, whereby it is indicated that the message sent contains 13 segments.

EDIFACT files have a hierarchical structure. The top level element is referred to a message. A message is a sequence of groups and segments. A group or segment can be mandatory (M) or conditional (C) and can be specified to repeat, for example CVVVV would indicate between 0 and VVVV repetitions of a segment or group, whereas MVVVV would mean between 1 and VVVV repetitions.

A group, like a message, is a sequence of segments or groups. The first segment/group beneath a group must be mandatory. If the logic of the situation demands it is conditional, then the group itself should be made conditional instead.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with processes for analyzing changes in EDI schema in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for analyzing changes in EDI schema of the invention.

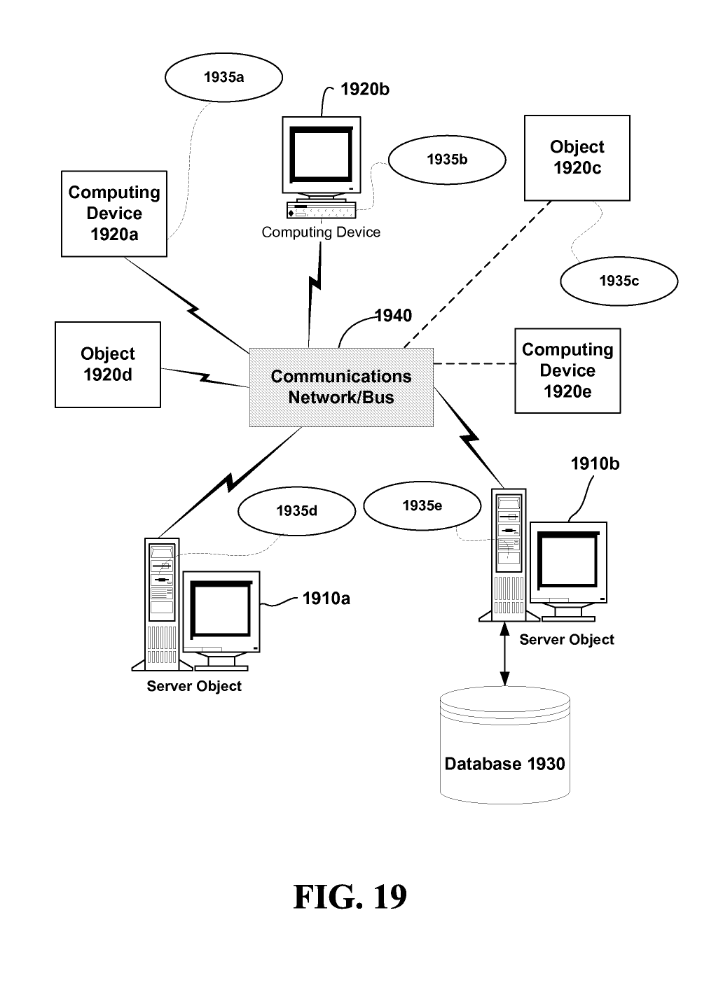

FIG. 19 provides a schematic diagram of an exemplary networked or distributed computing environment. The distributed computing environment comprises computing objects 1910a, 1910b, etc. and computing objects or devices 1920a, 1920b, 1920c, 1920d, 1920e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1940. This network may itself comprise other computing objects and computing devices that provide services to the system of FIG. 19, and may itself represent multiple interconnected networks. In accordance with an aspect of the invention, each object 1910a, 1910b, etc. or 1920a, 1920b, 1920c, 1920d, 1920e, etc. may contain an application that might make use of an API, or other object, software, firmware and/or hardware, suitable for use with the systems and methods for analyzing changes in EDI schema in accordance with the invention.

It can also be appreciated that an object, such as 1920c, may be hosted on another computing device 1910a, 1910b, etc. or 1920a, 1920b, 1920c, 1920d, 1920e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to analyzing changes in EDI schema according to the present invention.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 19, as an example, computers 1920a, 1920b, 1920c, 1920d, 1920e, etc. can be thought of as clients and computers 1910a, 1910b, etc. can be thought of as servers where servers 1910a, 1910b, etc. maintain the data that is then replicated to client computers 1920a, 1920b, 1920c, 1920d, 1920e, etc., although any computer can be considered a client, a server, or both, depending on the circumstances. Any of these computing devices may be processing data or requesting services or tasks that may implicate the analysis of changes of EDI schema in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for analyzing changes in accordance with the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 19 illustrates an exemplary networked or distributed environment, with server(s) in communication with client computer (s) via a network/bus, in which the present invention may be employed. In more detail, a number of servers 1910a, 1910b, etc. are interconnected via a communications network/bus 1940, which may be a LAN, WAN, intranet, GSM network, the Internet, etc., with a number of client or remote computing devices 1920a, 1920b, 1920c, 1920d, 1920e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to version EDI schema.

In a network environment in which the communications network/bus 1940 is the Internet, for example, the servers 1910a, 1910b, etc. can be Web servers with which the clients 1920a, 1920b, 1920c, 1920d, 1920e, etc. communicate via any of a number of known protocols such as HTTP. Servers 1910a, 1910b, etc. may also serve as clients 1920a, 1920b, 1920c, 1920d, 1920e, etc., as may be characteristic of a distributed computing environment.

As mentioned, communications may be wired or wireless, or a combination, where appropriate. Client devices 1920a, 1920b, 1920c, 1920d, 1920e, etc. may or may not communicate via communications network/bus 14, and may have independent communications associated therewith. For example, in the case of a TV or VCR, there may or may not be a networked aspect to the control thereof. Each client computer 1920a, 1920b, 1920c, 1920d, 1920e, etc. and server computer 1910a, 1910b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 1910a, 1910b, 1920a, 1920b, 1920c, 1920d, 1920e, etc. may be responsible for the maintenance and updating of a database 1930 or other storage element, such as a database or memory 1930 for storing data processed or saved according to the invention. Thus, the present invention can be utilized in a computer network environment having client computers 1920a, 1920b, 1920c, 1920d, 1920e, etc. that can access and interact with a computer network/bus 1940 and server computers 1910a, 1910b, etc. that may interact with client computers 1920a, 1920b, 1920c, 1920d, 1920e, etc. and other like devices, and databases 1930.

### Exemplary Computing Device

As mentioned, the invention applies to any device wherein it may be desirable to analyze differences in EDI schema. It should be understood, therefore, that handheld, portable and other computing devices and computing objects of all kinds are contemplated for use in connection with the present invention, i.e., anywhere that a device may interact with an EDI communications system or otherwise receive, process or store EDI data. Accordingly, the below general purpose remote computer described below in FIG. 20 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 20 thus illustrates an example of a suitable computing system environment 2000a in which the invention may be implemented, although as made clear above, the computing system environment 2000a is only one example of a suitable computing environment for a media device and is not intended to suggest any limitation as to the scope of use or functionality of the invention. Neither should the computing environment 2000a be interpreted as having any dependency or requirement relating to any one or combination of components illustrated in the exemplary operating environment 2000a.

With reference to FIG. 20, an exemplary remote device for implementing the invention includes a general purpose computing device in the form of a computer 2010a. Components of computer 2010a may include, but are not limited to, a processing unit 2020a, a system memory 2030a, and a system bus 2021a that couples various system components including the system memory to the processing unit 2020a. The system bus 2021a may be any of several types of bus structures including a memory bus or memory controller, a peripheral bus, and a local bus using any of a variety of bus architectures.

Computer 2010a typically includes a variety of computer readable media. Computer readable media can be any available media that can be accessed by computer 2010a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 2010a. Communication media typically embodies computer readable instructions, data structures, program modules or other data in a modulated data signal such as a carrier wave or other transport mechanism and includes any information delivery media.

The system memory 2030a may include computer storage media in the form of volatile and/or nonvolatile memory such as read only memory (ROM) and/or random access memory (RAM). A basic input/output system (BIOS), containing the basic routines that help to transfer information between elements within computer 2010a, such as during start-up, may be stored in memory 2030a. Memory 2030a typically also contains data and/or program modules that are immediately accessible to and/or presently being operated on by processing unit 2020a. By way of example, and not limitation, memory 2030a may also include an operating system, application programs, other program modules, and program data.

The computer 2010a may also include other removable/non-removable, volatile/nonvolatile computer storage media. For example, computer 2010a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 2021a through a non-removable memory interface such as an interface, and a magnetic disk drive or optical disk drive is typically connected to the system bus 2021a by a removable memory interface, such as an interface.

A user may enter commands and information into the computer 2010a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 2020a through user input 2040a and associated interface(s) that are coupled to the system bus 2021a, but may be connected by other interface and bus structures, such as a parallel port, game port or a universal serial bus (USB). A graphics subsystem may also be connected to the system bus 2021a. A monitor or other type of display device is also connected to the system bus 2021a via an interface, such as output interface 2050a, which may in turn communicate with video memory. In addition to a monitor, computers may also include other peripheral output devices such as speakers and a printer, which may be connected through output interface 2050a.

The computer 2010a may operate in a networked or distributed environment using logical connections to one or more other remote computers, such as remote computer 2070a, which may in turn have media capabilities different from device 2010a. The remote computer 2070a may be a personal computer, a server, a router, a network PC, a peer device or other common network node, or any other remote media consumption or transmission device, and may include any or all of the elements described above relative to the computer 2010a. The logical connections depicted in FIG. 20 include a network 2071a, such local area network (LAN) or a wide area network (WAN), but may also include other networks/buses. Such networking environments are commonplace in homes, offices, enterprise-wide computer networks, intranets and the Internet.

When used in a LAN networking environment, the computer 2010a is connected to the LAN 2071a through a network interface or adapter. When used in a WAN networking environment, the computer 2010a typically includes a communications component, such as a modem, or other means for establishing communications over the WAN, such as the Internet. A communications component, such as a modem, which may be internal or external, may be connected to the system bus 2021a via the user input interface of input 2040a, or other appropriate mechanism. In a networked environment, program modules depicted relative to the computer 2010a, or portions thereof, may be stored in a remote memory storage device. It will be appreciated that the network connections shown and described are exemplary and other means of establishing a communications link between the computers may be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the apparatus, methods, etc. for analyzing changes in EDI schema in accordance with the invention may be included in, supported in or accessed via all of the languages and services enabled by managed code, such as .NET code, and in other distributed computing frameworks as well.

There are multiple ways of implementing the present invention, e.g., an appropriate API, tool kit, driver code, operating system, control, standalone or downloadable software object, etc. which enables applications and services to use the tools, systems and methods for analyzing changes in EDI schema in accordance with the invention. The invention contemplates the use of the invention from the standpoint of an API (or other software object), as well as from a software or hardware object that receives EDI schema and analyzes and/or displays the EDI schema and associated changes in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to version EDI schema. For instance, the differencing analysis component and/or user interface tools of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the difference analysis capabilities of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 11, 12 and 13. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for analyzing EDI schema. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for analyzing an electronic data interchange (EDI) schema for one or more changes, including:
receiving at least one tree-based representation of EDI transaction set definition (TSD) information;
determining a plurality of EDI schema elements that comprise the EDI TSD information; and
for at least one EDI schema element of the plurality of the EDI schema elements, determining at least one change that changed the at least one EDI schema element from a previous version.

2. The method of claim 1, further including:
displaying the at least one change as a list of changes to the at least one EDI schema element.

3. The method of claim 1, further including:
displaying the at least one change to the at least one EDI schema element on an element-by-element basis.

4. The method of claim 1, wherein the determining includes determining at least one change to a property of the at least one EDI schema element.

5. The method of claim 1, wherein the determining includes determining at least one structural change to the tree-based representation of the EDI TSD information based on the at least one change to the at least one EDI schema element.

6. The method of claim 1, wherein the determining includes determining at least one change based on a “move” command that moves at least one EDI schema element from one position in the tree-based representation of the EDI TSD information to another.

7. The method of claim 1, wherein said determining includes determining at least one change to at least one of a data type, simple data element, composite data element, segment or loop that comprise the at least one schema.

8. A computer readable medium comprising computer executable instructions for performing the method of claim 1.

9. A computing device comprising means for performing the method of claim 1.

10. A server object for interfacing with a data store that stores a plurality of EDI schema as a plurality of EDI schema elements, including:
a difference analysis component that receives from the data store a designated version of an EDI schema represented as a first tree-based structure, compares the designated version to a second version of the EDI schema represented as a second tree-based structure, and determines at least one difference between at least one EDI schema element of a plurality of EDI schema elements comprising the first tree-based structure and at least one EDI schema element of a plurality of EDI schema elements comprising the second tree-based structure; and
an interface component for interfacing to the data store on behalf of the difference analysis component to retrieve the first and second tree-based structures.

11. The server object of claim 10, wherein the data store is a relational data store and the first and second tree-based structures are represented in relational format.

12. The server object of claim 10, wherein the plurality of EDI schema elements of the first and second tree-based structures include at least one of an EDI data type, an EDI simple data element, an EDI composite data element, an EDI segment or an EDI loop.

13. The server object of claim 10, further comprising:
a conversion component that converts the at least one of the designated version or the second version from an extensible markup language (XML) representation of the plurality of EDI schema elements prior to receiving the first tree-based structure or second tree-based structure, respectively.

14. The server object of claim 10, wherein the at least one difference includes at least one of a creation of an EDI schema element, modification of an EDI schema element or a deletion of an EDI schema element.

15. An editing tool for electronic data interchange (EDI) transaction set definitions (TSDs), including:
a change analysis component that receives at least one tree-based representation of a plurality of EDI schema elements comprising at least one EDI TSD and determines at least one change that previously changed at least one EDI schema element of the plurality of EDI schema elements; and
a user interface component that displays the at least one EDI TSD and displays the at least one change to the at least one EDI schema element.

16. The user interface according to claim 15, wherein the user interface component includes a tree-based view of the plurality of EDI schema elements comprising the at least one EDI TSD.

17. The user interface according to claim 15, wherein the user interface component enables editing of an EDI schema element of the plurality of EDI schema elements to create a new version of the at least one EDI TSD.

18. The user interface according to claim 15, wherein the user interface component includes a property editing component enabling editing of property values of properties associated with the plurality of EDI schema elements comprising the at least one EDI TSD.

19. The user interface according to claim 18, wherein the property editing component edits property values of at least one of a Name value, a Type of the node, a Description, a Cardinality of the element or a Count of component fields.

20. The user interface according to claim 15, wherein the user interface component includes a structure editing component that edits a hierarchical structure of the at plurality of EDI schema elements.
